(19) United States
(12) Patent Application Publication
(10) Pub. No.: US 2009/0168082 A1
(43) Pub. Date: Jul. 2, 2009

(54) METHODS AND APPARATUS FOR AN OUTPUT LOOKUP TABLE DESIGN AND DATA ACCESS LAYER IN COLOR MANAGEMENT RESOURCE ENGINES

(76) Inventors: Jean M. Aschenbrenner, Boulder, CO (US); Yue Qiao, Longmont, CO (US)

Correspondence Address: DUFT BORNSEN & FISHMAN, LLP, 1526 SPRUCE STREET, SUITE 302, BOULDER, CO, 80302, US

(21) Appl. No.: 11/966,170

(22) Filed: Dec. 28, 2007

(51) Int. Cl. H04N 1/60

(52) U.S. Cl. 358/1.9

(57) ABSTRACT

Methods and apparatus for saving and re-using lookup tables (LUTs) used in generating color data objects in a presentation/printing system. A data object is generated by a device or application having an associated input ICC profile and is transferred to a presentation device having one or more associated output ICC profiles. The data object is converted from its input color space to a color space of the presentation device based on calculated LUTs. Once calculated, the LUTs are saved in a memory of the presentation device to be re-used for processing of a subsequent data object. The saved LUTs are indexed using the object ID (OID) of the ICC output profile used to calculate the LUT. A subsequent data object may specify use of the same ICC output profile such that the previously calculated LUT may be retrieve and re-used to obviate the calculation burden to recalculate the LUT.

### RELATED PATENTS

This patent application relates to commonly owned, co-pending patent applications:
U.S. patent application Ser. No. 11/077,689, filed 11 Mar. 2005;
U.S. patent application Ser. No. 11/077,687, filed 11 Mar. 2005;
U.S. patent application Ser. No. 11/077,688, filed 11 Mar. 2005; and
U.S. patent application Ser. No. 11/145,820, filed 6 Jun. 2005,
   all of which are hereby incorporated by reference.

### BACKGROUND

1. Field of the Invention

The invention relates generally to methods and apparatus in a printing system to improve access to color conversion lookup tables in a color management resource engine (CMRE). More specifically, the invention relates to methods and apparatus for caching and accessing an output lookup table used in a printing system for color conversion of input data objects.

2. Discussion of Related Art

In color presentation devices (e.g., color printers and displays) a color object is typically created by a device or application and transferred to the presentation device for output to a user. The device or application that generated the color data object has a color profile associated therewith. This color profile defines parameters and aspects of the color capabilities of the device or application. This profile may be referred to herein as an input profile. Most importantly, this input profile defines the input color space for the device/application that generated the data object—e.g., the encoding of the various colors generated by the device/application. The presentation device typically has different color capabilities and thus has different parameters and aspects defining its capabilities. The parameters of the presentation device are defined in a color profile associated with the presentation device and is referred to herein as an output profile. In like manner, the output profile includes a definition of the output color space—e.g., the encoding of various colors capable of generation on the presentation device.

As is generally known in the art, the parameters that define the color capabilities of a device or application (i.e., the color space) may be specified in a number of different manners. Color space may be defined, for example, in an “RGB space” (defined in terms of red, green, and blue colors) or may be defined, for example, in a “CMYK space” (defined in terms of cyan, magenta, yellow, and block colors). Numerous other encodings or color spaces may be used to define capabilities of a device or application and are well known to those of ordinary skill in the art.

Further, the format for defining such input or output profile information has been defined by an industry consortium, namely, the International Color Consortium (ICC see, e.g., www.color.org). ICC specifications provide an ICC profile as a standardized format for defining the color profile information for a device or application. Device profiles provide color management systems with the information necessary to convert color data between native device color spaces and device independent color spaces. For each device class (input devices, output devices and others), a series of base algorithmic models are described which perform the transformation between color spaces. These models provide a range of color quality and performance results which provide different trade-offs in memory footprint, performance and image quality.

The ICC device profiles are standardized and obtain their openness by using a well-defined reference color space and by being capable of being interpreted by any ICC operating system or application that is compliant with the specification. In combination with profiles for other devices color transformations may be determined that enable colors captured on one device (e.g., an input device such as a scanner, a camera, etc.) to be reproduced satisfactorily on many other devices (e.g., output devices such as printers, etc.). The information required in the profile is adequate to ensure the level of color fidelity selected by the user and for the design of a default color management module (CMM) to transform color information between native device color spaces. Such CMMs are found in many operating systems and applications.

In processing a color object in a presentation device (e.g., an output device such as a printing system), the device controller performs calculations to convert the color space defined in the input profile associated with the input device/application that generated the color object into the color space of the presentation device. This conversion is performed according to ICC specification through a profile connection space (PSC). This connection space interface provides an unambiguous connection between the input and output profiles. It allows the profile transforms for input and output devices to be decoupled so that they can be produced independently. The well-defined PCS of ICC specifications provides the common interface for the individual device profiles. It is the virtual destination for input transforms and the virtual source for output transforms. If the input and output transforms are based on the same PCS definition, even though they are created independently, they can be paired arbitrarily at run time by the color-management engine (CMM) and will yield consistent and predictable results when applied to color values. In general, a pixel value is converted from the input device color space using information in the input profile into a form defined by the PSC. This intermediate value may then be converted from the PSC form into the color space of the output device by use of information in the output profile. Thus a pixel value is converted from the input device color space to the output device color space through the intermediate form of the PSC.

In an Advanced Function Presentation (AFP) environment as defined by InfoPrint Solutions Company and IBM a Color Management Resource Engine (CMRE) creates Color Management Resource (CMR) objects to perform color management. These CMRs include Color Conversion CMRs, Link Color Conversion CMRs, Index CMRs, etc. A Color Conversion CMR may be an ICC input profile (also sometimes referred to as an audit profile) or may be an ICC output profile (also sometimes referred to as an instruction profile).

An ICC profile (and hence an AFP CMR) may specify color information in a variety of ways including, for example, equations that are applied to a pixel value and lookup tables (LUT) that provide for interpolation of a pixel value by interpolating between table entry values. In an AFP presentation device some CMR objects are defined as LUTs in compliance with the ICC profile standards. In AFP devices, there are various situations that require computation of an output LUT to be associated with a Color Conversion CMR. A Link CMR is generated by combining the ICC input profile (e.g., the CMR) of the device or application that generated an AFP graphical data object and the ICC output profile (e.g., CMR) of the presentation device on which the AFP data object is to be presented (i.e., rendered). Other scenarios in the AFP architecture (e.g., certain use of Index CMRs) may also call for calculation of an output LUT in association with a CMR representing certain color capabilities of the AFP presentation device. For these various cases, an output LUT needs to be calculated and as part of a Color Conversion CMR to perform color conversions into the color space of the AFP presentation device. Processing a Color Conversion CMR and in particular calculating the output LUT associated with a CMR involves intensive calculations. It is not efficient if a Color Conversion CMRs is repeatedly being processed whenever it is used repeatedly by AFP graphic data objects that happen to use the same input ICC profile.

It is evident from the above discussion that an ongoing need exists for improved methods and apparatus for reducing the calculation burden on an AFP presentation device to repeatedly calculate a Color Conversion CMR (i.e., the output LUTs used therein) each time the same CMR is used.

### SUMMARY

The present invention solves the above and other problems, thereby advancing the state of the useful arts, by providing methods and apparatus for saving and re-using output LUTs calculated for a first data object in rendering other data objects.

One aspect hereof provides a method for managing a lookup table (LUT) in a color presentation device. The method includes receiving a color data object to be rendered by the presentation device wherein the data object is associated with an ICC output profile of the presentation device and wherein the ICC output profile is associated with an object identifier (OID). The method then attempts to retrieve an output LUT from a database using the OID as an index value in the database. Responsive to failure to retrieve the output LUT, continues by calculating entries of the output LUT from the ICC output profile associated with the OID and storing the output LUT in the database for later re-use wherein the step of storing associates the stored output LUT with the OID as an index value. The method then renders the data object based in part on the output LUT and presents the rendered data object to a user.

Another aspect hereof provides a method operable in an advanced function presentation (AFP) compliant presentation device for managing an output lookup table (LUT) used for processing of color data objects. The method includes, responsive to receipt of a color data object, generating a Color Conversion Color Management Resource (CMR) for processing the color data object on the presentation device wherein the step of generating includes creating an output lookup table (LUT). The method then saves the output LUT in a memory associated with the presentation device and uses the output LUT to process the color data object. Responsive to receipt of another color data object, the method uses the saved output LUT to process said another data object and presents the processed data objects to a user.

### BRIEF DESCRIPTION OF THE DRAWINGS

FIG. 1 is a block diagram of an exemplary printing system enhanced in accordance with features and aspects hereof to save calculated output LUTs for re-use in rendering subsequent data objects.

FIGS. 2 and 3 are flowcharts describing exemplary methods in accordance with features and aspects hereof to save calculated output LUTs for re-use in rendering subsequent data objects.

FIG. 4 is a block diagram of an exemplary system that may include a computer readable medium embodying methods in accordance with features and aspects hereof to save calculated output LUTs for re-use in rendering subsequent data objects.

### DETAILED DESCRIPTION OF THE DRAWINGS

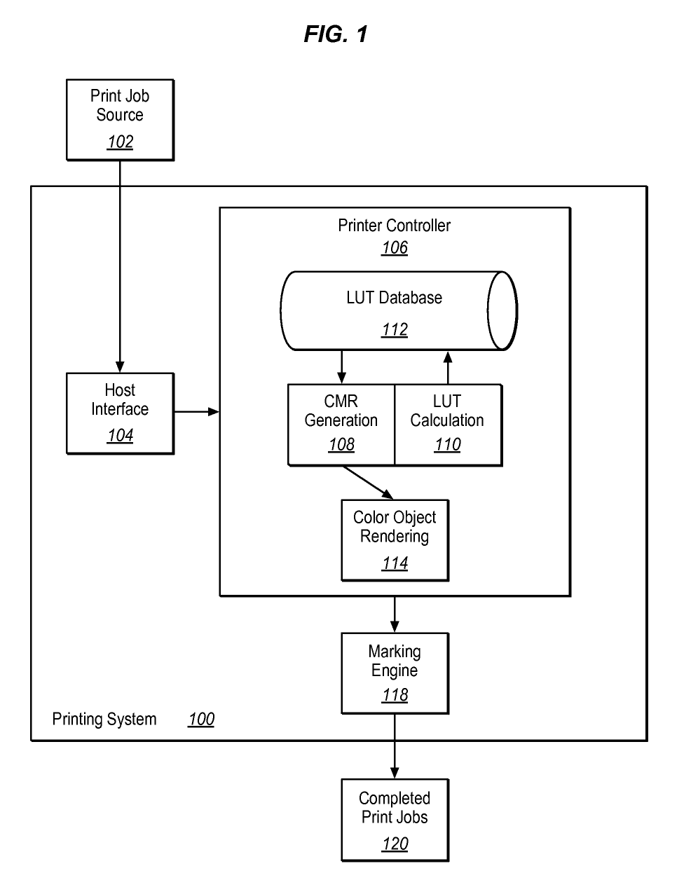

FIGS. 1 through 4 and the following description depict specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 is a block diagram of a printing system 100 enhanced in accordance with features and aspects hereof to save calculated LUTs for re-use in rendering subsequent data objects. Printing system 100 includes printing controller 106 adapted to receive and process print jobs from a print job source 102 received through host interface 104. Printer controller 106 renders/rasterizes data objects received in such print jobs and transfers the rendered images to marking engine 118 for imprinting on suitable printable media as completed jobs 120. Printing system 100 may be any suitable printing system adapted for imprinting utilizing any marking technique such as liquid ink deposition, dry toner, etc. Further, marking engine 118 may imprint on cut sheets of printable media or make imprint on continuous forms of printable media. In particular, printing system 100 and printer controller 106 are adapted to process full color images provided as color data objects in received print jobs.

Printer controller 106 may include CMR generation element 108 adapted to generate an AFP CMR (such as a Link CMR) useful in rendering AFP color data objects. As is generally known in the art, an AFP Link CMR, for example, is generated using complex calculations involving an input ICC profile, an output ICC profile, and a rendering intent associated with the received data object. The input profile to be used may often be specified as a part of the received data object (e.g., a Color Conversion CMR associated with the received AFP color data object and incorporating input ICC profile information within the CMR). Similarly, the rendering intent may be specified as a part of the data object (e.g., as above, within a Color Conversion CMR that is associated with the received AF color data object). Lastly, the output profile to be used in processing of the color data object may be specified in a variety of manners. As above, the output profile may be associated with the received color data object. Or, for example, the output profile may be specified as a global or default parameter of the presentation device such that the same output profile is used for processing of all received color objects. Still further, an output profile may be generated and downloaded to the presentation device from an attached system and then applied for use within a particular portion of an associated job (e.g., for a particular page, group of pages, portions of page, or an entire document). In the AFP architecture, the output profile may also be formatted as a Color Conversion CMR. Details of command syntax and semantics for associating a received data object with ICC profiles and rendering intent are specific to any particular command specifications.

In general, ICC profiles may specify various parameters associated with the color space of a generated data object and/or the color space of a presentation device such as printing system 100. Detailed specifications of parameters, fields, and values in such input and output ICC profiles as well as various types of rendering intent indicia are well defined in industry standard specifications publicly available from the ICC and are well known to those of ordinary skill in the art. These parameters may be specified in a number of well defined formats including, for example, LUTs. In the AFP architecture, CMRs are used, for example, to define color conversion and translation processing parameters between an input ICC profile of the data object and an output ICC profile of the presentation device. The color data object is converted or translated into the ICC PSC color space based on the input ICC profile and thence from the PSC color space into corresponding colors based on the output ICC profile of the printing system 100.

As an aspect of these complex calculations to generate an output profile (e.g., an AFP CMR), one or more look up tables (LUTs) may be generated and associated with the output ICC profile or AFP CMR of the printing system 100. Thus, CMR generation element 108 works in close cooperation with the LUT calculation element 110 to generate output LUT entries useful in color conversion of a particular received data object. LUT calculation element 110 is adapted in accordance with features and aspects hereof to save such computed output LUTs in LUT database 112. LUT database 112 represents any suitable memory within the printing system 100 (or accessible through appropriate networking features of printing system 100) and is typically indexed for rapid access to entries stored therein. Calculation element 110 saves a generated output LUT in LUT database 112 associated with an index value to allow rapid retrieval. Preferably, the index value may include an object identifier (OID) associated with an output ICC profile used for rendering within printing system 100 (or the Color Conversion CMR in the AFP architecture). Other index values may also be specified to allow rapid location and retrieval of a particular output LUT within LUT database 112.

CMR generation element 108 is further adapted in accordance with features and aspects hereof to attempt to retrieve a necessary output LUT from LUT database 112 before calculating a necessary output LUT utilizing LUT calculation element 110. Thus in processing of each data object, CMR generation element 108 first queries the LUT database 112 to determine whether the needed output LUT has already been calculated and saved in LUT database 112. CMR generation element 108 preferably uses one or more index values associated with the required output LUT if/when it was stored in database 112. As above, the object ID (OID) of the ICC output profile (or AFP CMR) used to convert the color data object is one example of a useful index to rapidly locate and retrieve a desired output LUT from database 112. If CMR generation element 108 a successful in retrieving a desired output LUT from data base 112, generation of a necessary CMR may be more rapidly completed by avoiding the complex computations required to initially generate an output LUT. The CMR generation may then be completed using the retrieved output LUT and is then utilized (along with other conversion tables and information) by color object rendering element 114 to render the data object utilizing the generated CMR and the retrieved output LUT. If CMR generation element 108 is not successful in locating and retrieving a desired output LUT from database 112, the normal computation techniques are applied in conjunction with LUT calculation element 110 to generate the required output LUT anew. The newly generated output LUT, as noted above, is then stored in database 112 (by calculation element 110) for re-use in processing subsequent data objects.

Those of ordinary skill in the art will readily recognize a variety of additional modules or elements operable within a typical printer controller 106 and a typical printing system 100. Such additional elements are eliminated herein for simplicity and brevity of this discussion and are well known to those of ordinary skill in the art. Still further, the particular modular decomposition of elements shown within printing system 100 and printer controller 106 are intended merely as suggestive or exemplary of one possible modular decomposition. The elements of printing system 100 may be integrated in a different manner or separated in a different manner than that shown in FIG. 1. Further, though shown as integrated within the operation of a printer controller 106 of a printing system, such profile or CMR processing may also be performed in a print server or other computing nodes associated with a printing system 100. Thus the features and aspects hereof for saving and re-using generated output LUTs may be equally applicable to other computational systems where ICC profile or AFP CMR processing may be performed. FIG. 1 is thus intended merely as exemplary of one possible arrangement of elements and modules within a printing system 100 in accordance with features and aspects hereof.

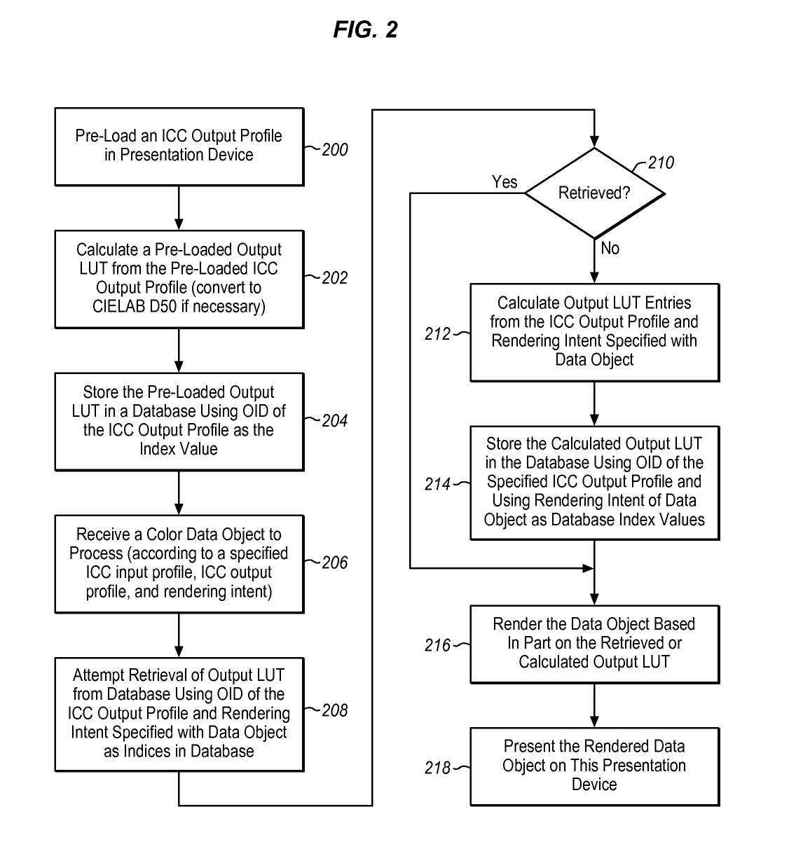

FIG. 2 is a flowchart describing an exemplary method in accordance with features and aspects hereof for saving output LUTs generated in the processing of one or more data objects for re-use in processing of subsequent data objects. Step 200 pre-loads an ICC output profile associated with the presentation device into an appropriate memory of the presentation device. Step 202 then calculates a pre-loaded output LUT from the pre-loaded ICC output profile. If not already so specified, the color space in the calculated, pre-loaded output LUT is preferably converted to CIELAB D50 to allow for maximum flexibility in combining with particular ICC input profiles associated with particular data objects to be processed. Step 204 stores the calculated, pre-loaded output LUT in a database of the printing system using the OID of the pre-loaded ICC output profile as an index value in the database. Any number of such pre-loaded output profiles and corresponding output LUTs may be pre-loaded in the presentation device or system. As noted above, the database may be implemented as any suitable memory providing for indexed retrieval of stored information.

Steps 200 through 204 may be performed as steps at the time of manufacture of the printing system and/or as steps performed at initial installation and setup of the printing system. Thus, a printing system as manufactured and/or as initially installed and configured in a user's environment may include one or more pre-loaded output LUTs useful in processing of one or more data objects to be received and processed. Steps 200 through 204 may be omitted such that all LUTs required for processing data objects will be computed if and when a particular data object requires calculation of a particular LUT.

Step 206 receives a next color data object from a print job source. The color data object is associated with a specified ICC input profile corresponding to the device or application that generated the color data object. The color data object is also associated with a specified ICC output profile associated with particular rendering parameters selected for this presentation device. As noted above, the data object may be associated with an output profile by specifying the output profile as part of the data object or as a state of the presentation device or system when the data object is encountered for processing. The color data object may also be associated with a rendering intent indicating certain rendering options to be applied in rendering of this data object. Where no particular ICC output profile and/or rendering intent is associated with the received data object, default parameters may be associated with the data object in accordance with the particular printing architecture.

Step 208 attempts to retrieve an output LUT from the LUT database using the OID of the associated (or default) ICC output profile and, optionally, the associated rendering intent. The OID and rendering intent may be used as indices into the LUT database as noted above. Step 210 then determines whether the required output LUT was successfully retrieved from the LUT database. If so, processing continues at step 216 to render the data object based in part on the retrieved output LUT. Step 218 then presents the rendered data object on this presentation device. If step 210 determines that the required output LUT was not located or retrieved, step 212 calculates the required output LUT entries from the ICC profiles and rendering intent associated with the data object. LUT entries generated by step 212 are then stored in the LUT database at step 214. As above, the OID of the ICC output profile and, optionally, the rendering intent may be used as index values to permit subsequent retrieval of this newly calculated output LUT. Steps 216 and 218 then render the data object using the newly calculated output LUT and present the rendered data object on this presentation device.

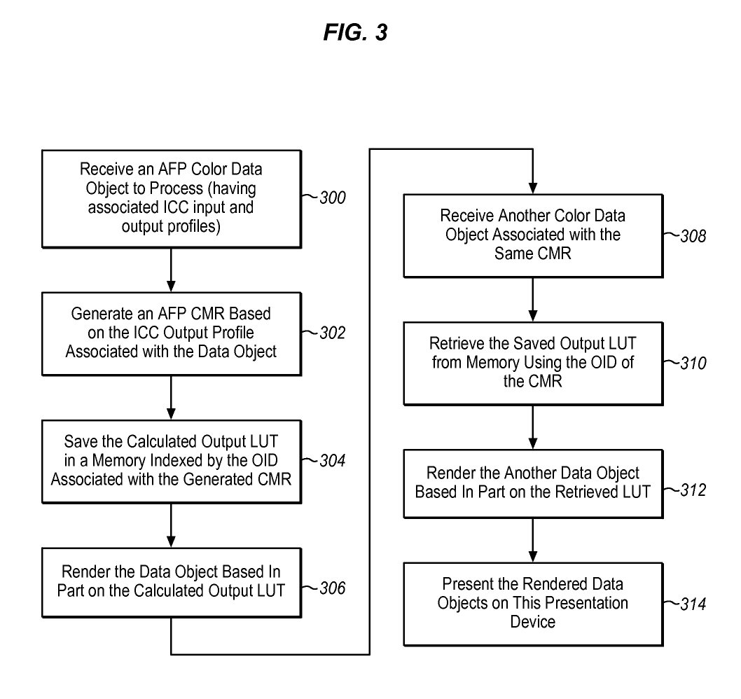

FIG. 3 is a flowchart describing another exemplary method in accordance with features and aspects hereof for saving and re-using output LUTs calculated as an aspect of generating an AFP CMR for converting and rendering color data objects. Step 300 first receives an AFP color data object to be processed. The color data object is associated with specified CMRs and/or profiles. Step 302 next generates an AFP CMR object based on information in the ICC profiles associated with the data object. The AFP CMR may be a Color Conversion CMR, a Link CMR, an Index CMR, etc. as well known to those of ordinary skill in the art. The CMR so generated creates one or more output LUTs used in the processing of the data object. Step 304 then saves the one or more output LUTs created by calculations in the generation of the CMR. The output LUTs are saved in an appropriate memory associated with the printing system. Further the OID of the generated CMR may be used as an index value to allow rapid retrieval of the output LUT for later re-use. Further, as noted above, the rendering intent may be used as an additional index value to allow storage and retrieval of a variety of output LUTs all generated based on the same CMR but applying different rendering intents. Step 306 renders the data object based in part on the output LUTs calculated in generation of the CMR at step 302.

Step 308 then receives another color data object. This next data object will also be associated with CMRs. If the CMR associated with this next data object is the same as the CMR associated with a previous data object (as indicated by the use of the same OID), step 310 may retrieve the required LUT from the memory in which it was stored. As above, the OID of the CMR and, optionally, the rendering intent associated with the output LUT calculations may be used to retrieve the required output LUT for re-use to process this next data object. Step 312 then renders the next data object using at least in part the retrieved LUT previously calculated and stored for re-use. Step 314 then presents the rendered data objects on the presentation device.

By storing and re-using the output LUTs generated in association with processing of a previous data (or pre-loaded in the system) the methods of FIGS. 2 and 3 reduce processing overhead time in the printing system to process color data objects.

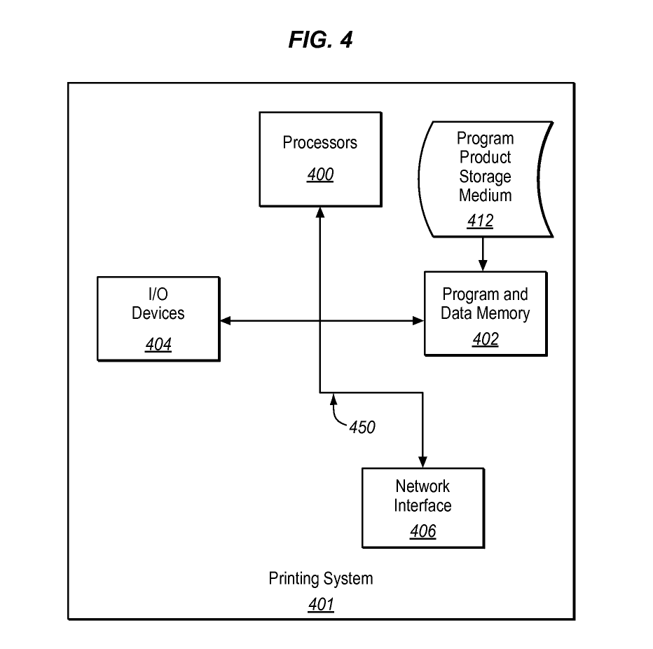

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc. FIG. 4 is a block diagram depicting a printing system 401 as a system adapted to provide features and aspects hereof by executing programmed instructions and accessing data stored on a computer readable storage medium 412.

Furthermore, the invention can take the form of a computer program product accessible from a computer-usable or computer-readable medium 412 providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 400 coupled directly or indirectly to memory elements 402 through a system bus 450. As noted above, processors may be distributed among various control elements of a printing system such as in a rasterizing printer controller and a page extractor post-processing element. The memory elements can include local memory employed during actual execution of the program code, bulk storage, and cache memories which provide temporary storage of at least some program code in order to reduce the number of times code must be retrieved from bulk storage during execution.

Input/output or I/O devices 404 (including but not limited to keyboards, displays, pointing devices, etc.) can be coupled to the system either directly or through intervening I/O controllers. Network adapter interfaces 406 may also be coupled to the system to enable the data processing system to become coupled to other data processing systems or storage devices through intervening private or public networks. Modems, cable modems, IBM Channel attachments, SCSI, Fibre Channel, and Ethernet cards are just a few of the currently available types of network or host interface adapters.

Although specific embodiments were described herein, the scope of the invention is not limited to those specific embodiments. The scope of the invention is defined by the following claims and any equivalents thereof.

What is claimed is:

1. A method for managing a lookup table (LUT) in a color presentation device, the method comprising:
receiving a color data object to be rendered by the presentation device wherein the data object is associated with an ICC output profile of the presentation device and wherein the ICC output profile is associated with an object identifier (OID);
attempting to retrieve an output LUT from a database using the OID as an index value in the database;
responsive to failure to retrieve the output LUT, performing the steps of:
calculating entries of the output LUT from the ICC output profile associated with the OID; and
storing the output LUT in the database for later re-use wherein the step of storing associates the stored output LUT with the OID as an index value;
rendering the data object based in part on the output LUT; and
presenting the rendered data object to a user.

2. The method of claim 1
wherein the data object is associated with a rendering intent,
wherein the step of attempting to retrieve includes attempting to retrieve the output LUT from the database using the OID and the rendering intent as index values in the database, and
wherein the step of storing associates the stored output LUT with the OID and with the rendering intent as index values.

3. The method of claim 3 wherein the profile conversion space (PCS) used in calculating the entries of the output LUT is CIELAB D50.

4. The method of claim 1
wherein an ICC output profile is pre-loaded in the presentation device at time of manufacture of the printing device wherein the pre-loaded ICC output profile is associated with the OID,
wherein the method further comprises
calculating entries of a pre-loaded output LUT from the pre-loaded ICC output profile associated with the OID; and
storing the pre-loaded output LUT in the database at time of manufacture of the presentation device for later re-use wherein the step of storing associates the stored, pre-loaded output LUT with the OID as an index value.

5. The method of claim 4 wherein the profile conversion space (PCS) used in calculating the entries of the pre-loaded LUT is CIELAB D50.

6. A method operable in an advanced function presentation (AFP) compliant presentation device for managing an output lookup table (LUT) used for processing of color data objects, the method comprising:
responsive to receipt of a color data object, generating a Color Conversion Color Management Resource (CMR) for processing the color data object on the presentation device wherein the step of generating includes creating an output lookup table (LUT);
saving the output LUT in a memory associated with the presentation device;
using the output LUT to process the color data object;
responsive to receipt of another color data object, using the saved output LUT to process said another data object; and
presenting the processed data objects to a user.

7. The method of claim 6
wherein the CMR is generated based on an ICC output profile associated with the presentation device.

8. The method of claim 6
wherein the CMR is associated with an object identifier (OID),
wherein the step of saving further comprises indexing the saved output LUT in the memory using the OID as an index value, and
wherein the step of using the saved output LUT further comprises retrieving the saved output LUT from the memory using the OID to locate the output LUT in the memory.

9. The method of claim 6 wherein the CMR is an AFP Link CMR.

10. The method of claim 6 wherein the CMR is an AFP Index CMR.

11. A computer readable medium tangibly embodying programmed instructions which, when executed by a computer in an advanced function presentation (AFP) presentation device, perform a method for managing a lookup table (LUT) used for rendering of color data objects, the method comprising:
responsive to receipt of a color data object, generating a Color Conversion Color Management Resource (CMR) for processing the color data object on the presentation device wherein the step of generating includes creating an output lookup table (LUT);
saving the output LUT in a memory associated with the presentation device;
using the output LUT to process the color data object;
responsive to receipt of another color data object, using the saved output LUT to process said another data object; and
presenting the processed data objects to a user.

12. The computer readable medium of claim 11
wherein the CMR is generated based on an ICC output profile associated with the presentation device.

13. The computer readable medium of claim 11
wherein the CMR is associated with an object identifier (OID),
wherein the step of saving further comprises indexing the saved output LUT in the memory using the OID as an index value, and
wherein the step of using the saved output LUT further comprises retrieving the saved output LUT from the memory using the OID to locate the output LUT in the memory.

14. The computer readable medium of claim 11 wherein the CMR is an AFP Link CMR.

15. The computer readable medium of claim 11 wherein the CMR is an AFP Index CMR.
